(19) United States
(12) Patent Application Publication
(10) Pub. No.: US 2007/0033603 A1
(43) Pub. Date: Feb. 8, 2007

(54) OBJECTIVE LENS DRIVING DEVICE, OPTICAL PICKUP, AND OPTICAL RECORDING/REPRODUCING APPARATUS

(75) Inventor: Keiji Suzuki, Tokyo (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: TDK CORPORATION, Tokyo (JP)

(21) Appl. No.: 11/461,595

(22) Filed: Aug. 1, 2006

(30) Foreign Application Priority Data
Aug. 5, 2005 (JP) 2005-228350
May 26, 2006 (JP) 2006-146362

(51) Int. Cl. G11B 7/00

(52) U.S. Cl. 720/681

(57) ABSTRACT

An objective lens driving device, an optical pickup, and an optical recording/reproducing apparatus having a construction which makes it possible to alleviate the restriction of the movement of the objective lens driving device to an inner peripheral side of an optical disk and the restriction of the movable range of a lens holder in consequence of the enlargement of the occupying space of a spindle motor in the objective lens driving device of a wire supported type. Both side surfaces of a lens holder 27 are fixed to one end side of wires 32 whose other end side is held on a wire base 33. The objective lens driving device has a cover 23 for covering at least the wire base 33. Of a pair of side plate portions 23d and 23f respectively corresponding to inner and outer sides, in the radial direction of the disk, of the cover 23, a portion of that portion which is in close proximity to an outer peripheral surface of a spindle motor in at least the inner side plate portion 23d is cut off.

### BACKGROUND OF THE INVENTION

The present invention relates to an objective lens driving device used for an optical disk such as a CD, a DVD, an MO, and an MD, and an optical pickup and an optical recording/reproducing apparatus each having the same, and more particularly to the structure of a cover which covers the objective lens driving device.

In an optical recording/reproducing apparatus, as disclosed in patent document 1, a spindle motor for rotating a disk for supporting an optical disk is provided, an optical pickup is installed movably in the radial direction of the disk, and an objective lens and its driving device are installed on the optical pickup. The objective lens driving device is covered and protected by a cover whose upper side for the objective lens is open. The cover disclosed in the patent document 1 has a portal shape which covers side portions respectively corresponding to inner and outer portions, in the radial direction of the disk, of the objective lens driving device. In addition, patent document 2 discloses a cover structured to cover both side portions corresponding to the inner and outer sides, in the radial direction of the disk, of the objective lens driving device, as well as a portion other than the opening in the top surface corresponding to the objective lens.

Because of the reason that operator's fingers come into contact with wires and a damping agent for holding the wires to a wire base in the manufacturing process, these covers are provided to prevent the deformation and breakage of the wires, and to prevent the deterioration of the damping agent due to adhesion or mixing in of oil and water with respect to the damping agent.

[Patent Document 1] JP-A-9-180223

[Patent Document 2] JP-A-2000-163770

In conjunction with the trend toward high-speed optical recording and reproduction in recent years, the capacity of the spindle motor has come to expand, and the occupying space in the radial direction has come to expand. In the situation in which the occupying space of the spindle motor has thus expanded, in a case where the conventional structure of the optical pickup is adopted, it becomes impossible to move the objective lens driving device to the inner peripheral side of the optical disk. In addition, if the side plate portion on the inner peripheral side of the cover is curved in an arcuate shape in conformity with the outer peripheral shape of the motor to prevent the collision of the cover with the spindle motor, there is a problem in that the operating range of a lens holder is restricted, and the movable range of the lens holder becomes narrow.

### SUMMARY OF THE INVENTION

In view of the above-described problems, an object of the invention is to provide an objective lens driving device, an optical pickup, and an optical recording/reproducing apparatus having a construction which makes it possible to alleviate the restriction of the movement of the objective lens driving device to the inner peripheral side of the optical disk and the restriction of the movable range of the lens holder in consequence of the enlargement of the occupying space of the spindle motor in the objective lens driving device of the wire supported type.

Another object of the invention is to provide an objective lens driving device, an optical pickup, and an optical recording/reproducing apparatus having a construction which makes it possible to prevent the deformation of a side plate portion in a case where the objective lens driving device is grasped with the operator's fingers.

In accordance with the invention there is provided an objective lens driving device which is mounted in an optical pickup in an optical reproducing or optical recording/reproducing apparatus which has a spindle motor for rotating a disk and in which the optical pickup is installed movably along a pair of guide arms provided in a radial direction of the disk, the objective lens driving device having a structure in which a lens holder is fixed to one end side of a support member whose other end side is held on a support base, the objective lens driving device comprising: a cover for covering at least a portion of the support member in a vicinity of the support base,

wherein of a pair of side plate portions respectively corresponding to inner and outer sides, in the radial direction of the disk, of the cover, a portion of that portion which is in close proximity to an outer peripheral surface of the spindle motor in at least the inner side plate portion is cut off.

In addition, the objective lens driving device in accordance with the invention is characterized in that the cover has a structure in which the cover is divided into a divided body for covering the support base and another divided body for covering an opposite side portion with the objective lens placed therebetween, the cut-off portion being formed between these divided bodies.

In addition, the objective lens driving device in accordance with the invention is characterized in that means is provided for preventing the deformation toward the inner side of a portion of the side plate portion located close to the cut-off portion.

In addition, the objective lens driving device in accordance with the invention is characterized in that a reentrant portion is provided in the vicinity of the cut-off portion on an inner surface of the side plate portion, and the reentrant portion is adapted to abut against a corner portion of the support base so as to prevent the deformation toward the inner side of the portion of the side plate portion located close to the cut-off portion.

In addition, the objective lens driving device in accordance with the invention is characterized in that the portion of the side plate portion located close to the cut-off portion is formed into a tapered shape, such that the closer to the cut-off portion, the more an outer surface of the side plate portion approaches a lens holder side.

An optical pickup in accordance with the invention is characterized by having any one of the above-described objective lens driving devices. An optical recording/reproducing apparatus in accordance with the invention is characterized by having the above-described optical pickup.

In the objective lens driving device in accordance with the invention, of the pair of side plate portions respectively corresponding to the inner and outer sides, in the radial direction of the disk, of the cover of the objective lens driving device, a portion of that portion which is in close proximity to an outer peripheral surface of the spindle motor in at least the inner side plate portion is cut off. Here, the cut-off portion of the cover is provided at a position which is closest to the spindle motor in the lens holder as the optical pickup is moved to the spindle motor side. Therefore, the structure of the cover in accordance with the invention is one in which that portion of the side plate portion of the objective lens driving device which is most likely to abut against the spindle motor is cut off. For this reason, even if the radius of the spindle motor becomes large, it becomes possible to move the objective lens driving device to the inner peripheral side.

In addition, with the structure in which the cut-off portion is provided as in the invention, as compared with the case where the side plate portion is curved, the movable range, in the radial direction of the disk, of the lens holder is not narrowed.

In addition, even with the structure in which the wire fixing portion for fixing the distal ends of the wires is exposed to the side surface portion of the lens holder, since the cut-off portion is restricted to only the portion corresponding to this wire fixing portion and its vicinity, when the operator grasps the cover in the manufacturing process, his fingers do not come into contact with the wires, and the contact with the damping agent provided on the wire base. Thus, it is possible to prevent such as the deformation and breakage of the wires and the deterioration of the damping agent.

In the invention, since the reentrant portion is provided in the vicinity of the cut-off portion on the inner surface of the side plate portion, and this reentrant portion is abutted against a corner portion of the wire base, so that the combination strength improves, and the bending of the side plate portion can be prevented.

In addition, in the invention, in a case where the wire fixing portion is made to project into the side surface of the lens holder, as described above, and a tying portion for such as a tracking coil and a focus coil is formed to project from the side surface of the lens holder, the cut-off portion of the side plate portion is formed by including the portion corresponding to the tying portion, thereby promoting the effect due to the provision of the cut-off portion. In other words, since the tying portion is formed in such a manner as to project from the side surface of the lens holder more than the wire fixing portion, with the structure in which this tying portion is covered by the side plate portion, the amount in which the side plate portion projects toward the inner side in the radial direction of the optical disk becomes large. However, by cutting off the portion of the side plate portion corresponding to this tying portion, it becomes possible to move the objective lens driving device to the inner peripheral side of the optical disk.

In addition, in the invention, the portion of the side plate portion close to the cut-off portion is formed into the tapered shape such that the closer to the cut-off portion, the more the outer surface of the side plate portion approaches the lens holder side. Therefore, a structure is easily realized which makes it possible to prevent the interference between the spindle motor and the side plate portion of the cover, and which permits the movement of the objective lens driving device to the inner peripheral side of the optical disk.

In addition, in the invention, if the cover has a structure in which it is divided into a divided body for covering the wire base and another divided body for covering an opposite side portion with the objective lens placed therebetween, and if the cut-off portion is formed between these divided bodies, since the two divided bodies are each provided with side plate portions on both sides and are respectively formed substantially symmetrically, it is possible to reduce the occurrence of strain during the molding and shrinkage of a plastic, thereby making it possible to make the fabrication error small.

### BRIEF DESCRIPTION OF THE DRAWINGS

FIG. 1 is a block diagram illustrating an example of an optical recording/reproducing apparatus to which an objective lens driving device and an optical pickup in accordance with the invention are applied;

FIG. 2 is a block diagram illustrating an embodiment of the optical pickup in accordance with the invention;

FIG. 3 is a plan view illustrating embodiments of the objective lens driving device and the optical pickup in accordance with the invention;

FIG. 4 is a perspective view illustrating the embodiment of the objective lens driving device in accordance with the invention;

FIG. 5 is a perspective view illustrating a state in which the cover of the objective lens driving device in accordance with the embodiment is removed;

FIGS. 6A, 6B, and 6C are a perspective view, a bottom view, and a side view, respectively, of the cover in accordance with the embodiment;

FIG. 7 is a bottom view of the objective lens driving device in accordance with the embodiment with a bottom of its yoke base omitted;

FIG. 8 is a perspective view illustrating another embodiment of the objective lens driving device in accordance with the invention;

FIGS. 9A, 9B, and 9C are a perspective view, a bottom view, and a side view, respectively, of the cover in accordance with the embodiment;

FIG. 10 is a bottom view of the objective lens driving device in accordance with the embodiment shown in FIG. 8 with the bottom of its yoke base omitted;

FIG. 11 is a perspective view illustrating still another embodiment of the objective lens driving device in accordance with the invention; and

FIG. 12 is a perspective view illustrating a state in which the cover of the objective lens driving device in accordance with the embodiment shown in FIG. 11 is removed.

### DETAILED DESCRIPTION OF THE PREFERRED EMBODIMENTS

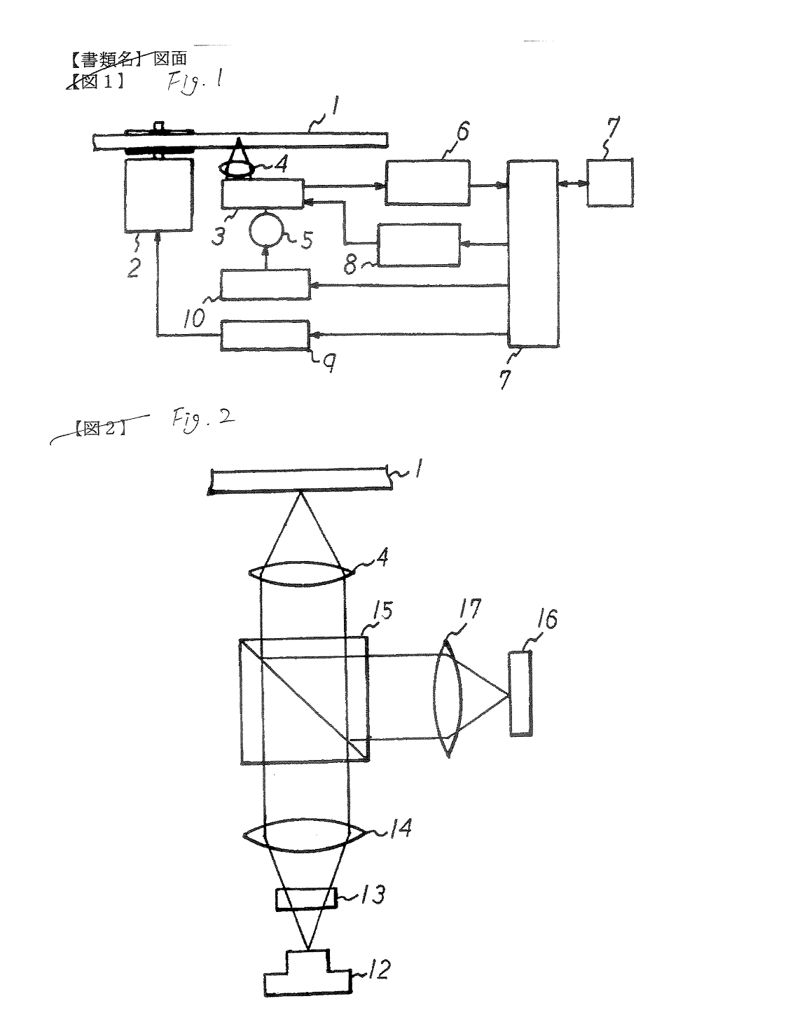

FIG. 1 is a block diagram illustrating an embodiment of an optical recording/reproducing apparatus to which an objective lens driving device in accordance with the invention is applied. In FIG. 1, reference numeral 1 denotes a recording medium (disk) which is constituted by an optical recording medium or a magneto-optical recording medium, and this recording medium 1 is rotated by a spindle motor 2. Reference numeral 3 denotes an optical pickup for performing recording and reproduction by applying laser light to the recording medium 1 through an objective lens 4. This optical pickup 3 has an objective lens driving unit mounted thereon to cause the objective lens 4 to follow the surface vibration and the track runout of the recording medium 1. A movable base constituting the optical pickup 3 is driven in the radial direction of the recording medium 1 by a coarse motor 5. An electrical signal which is photoelectrically converted by the optical pickup 3 is subjected to arithmetic processing by a signal processing system 6, and a tracking error signal, a focus error signal, a reproduction signal, and the like obtained by the arithmetic processing are inputted to a drive controller 7 for controlling the overall device. Reference numeral 8 denotes an optical pickup control system which performs the control of the output of laser light of the optical pickup 3 and emergent pulses, as well as the control of the operation of the objective lens driving unit on the basis of the error signal. Reference numeral 9 denotes a drive control system of the spindle motor 2, and numeral 10 denotes a drive control system of the coarse motor 5. Reference numeral 11 denotes an interface which performs transmission and reception of signals with external circuits. This optical recording/reproducing apparatus is incorporated in a cabinet.

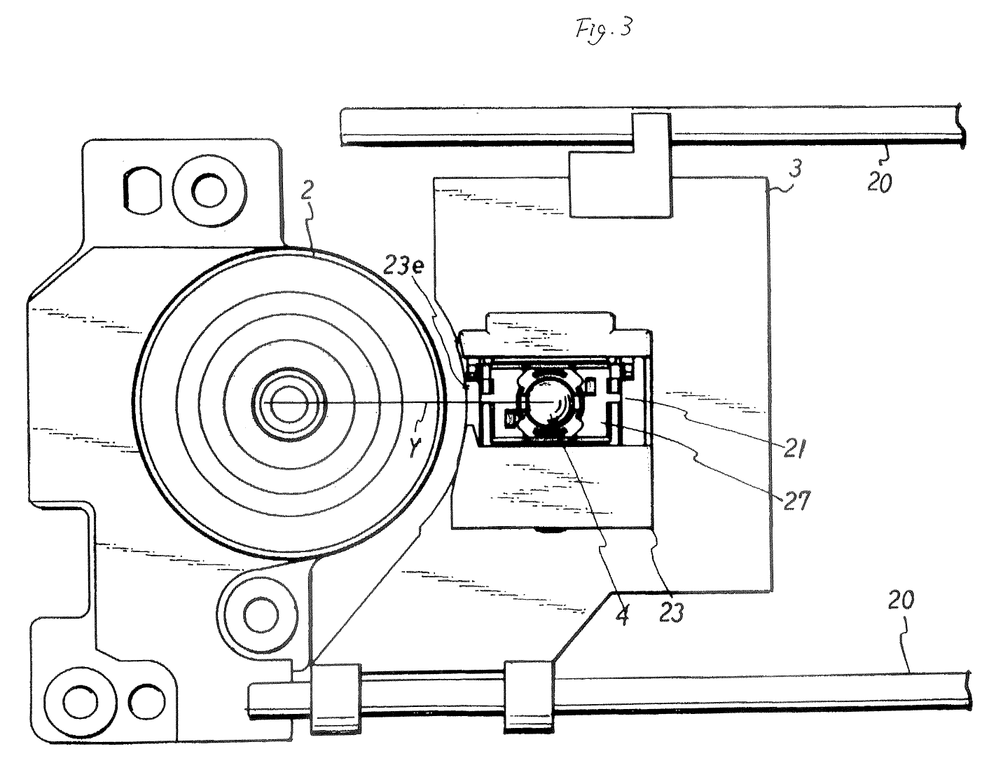

FIG. 2 is a block diagram illustrating an embodiment of the optical pickup 3 which employs the objective lens driving unit in accordance with the invention. In FIG. 2, reference numeral 12 denotes a light source constituted by a laser unit; 13, a diffraction element for splitting the laser light from the light source 12 into a plurality of beams; 14, a collimator lens for converting the laser light emergent from the diffraction element 13 into parallel light; and 15, a beam splitter. The beam splitter 15 transmits the light from the collimator lens 14 so as to be focused by the objective lens 4 and to be incident upon the recording medium (disk) 1, and reflects toward a detector 16 the reflected light reflected from the recording medium 1 and transmitted through the objective lens 4. Reference numeral 17 denotes an anamorphic lens for converging the reflected light from the beam splitter 15 onto the detector 16. This anamorphic lens 17 is a compound lens whose incident side is a cylindrical surface and whose emergent side is a concave surface. The concave surface is provided for the purposes of optimizing the magnification of the return path optical system and of making adjustment possible such that the information light is focused on the light receiving surface inside the detector 16 with an appropriate size by moving the anamorphic lens 17 in a direction along the optical axis.

When the information light is transmitted through the cylindrical surface of the anamorphic lens 17, the information light produces astigmatism, and this produces astigmatism is used for detection of a focus error. This focus error detection method is called an astigmatic method. The tracking error signal is obtained from a signal of the difference between two sub-beams obtained by allowing the laser light emitted from the light source 12 to pass through the diffraction element 13, or from a signal of the difference including the main beam. It should be noted that, in the invention, this tracking error signal may be obtained by a push-pull method, a wobbling method, or a heterodyne method. Further, as the method of forming the focus error signal, it is possible to use the knife-edge method, the Foucault method, and the critical angle method.

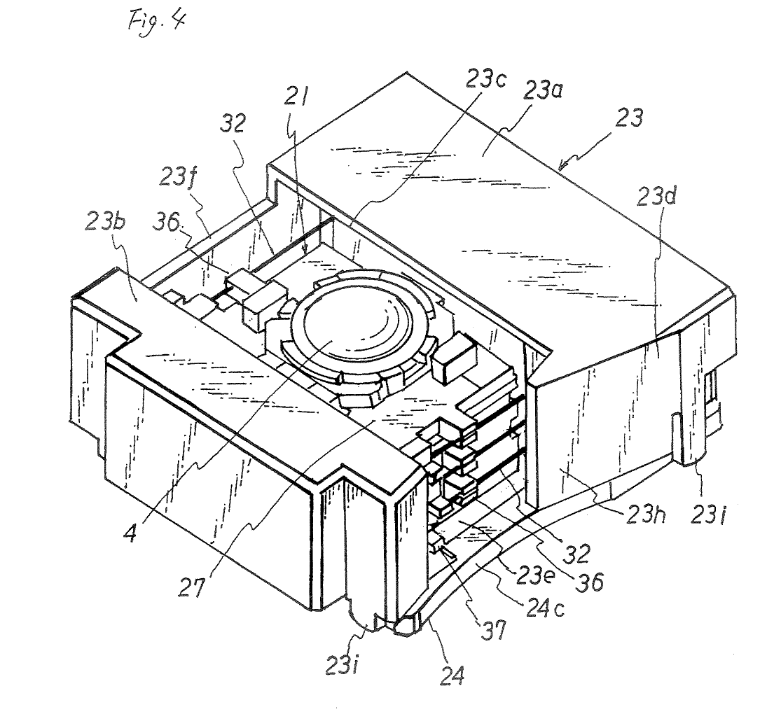

FIG. 3 is a plan view illustrating an embodiment of an objective lens driving device in accordance with the invention, together with the spindle motor and the like. In FIG. 3, reference numeral 20 denotes two guide arms provided in parallel with the radial direction of the disk 1, and the above-described optical pickup 3 is installed movably along these guide arms 20. The optical elements 12 to 17 shown in FIG. 2 and an objective lens driving device 21 are mounted on the optical pickup 3.

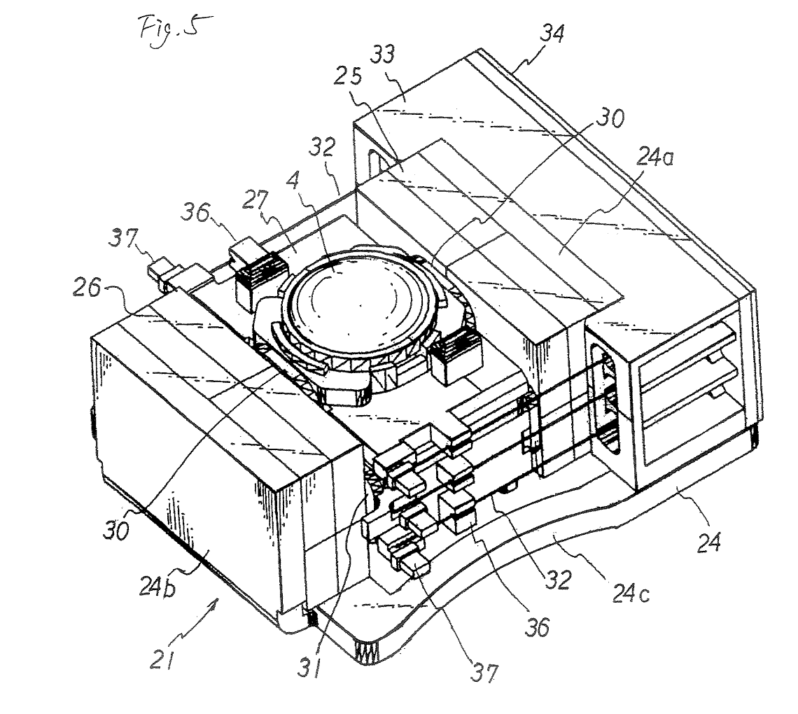

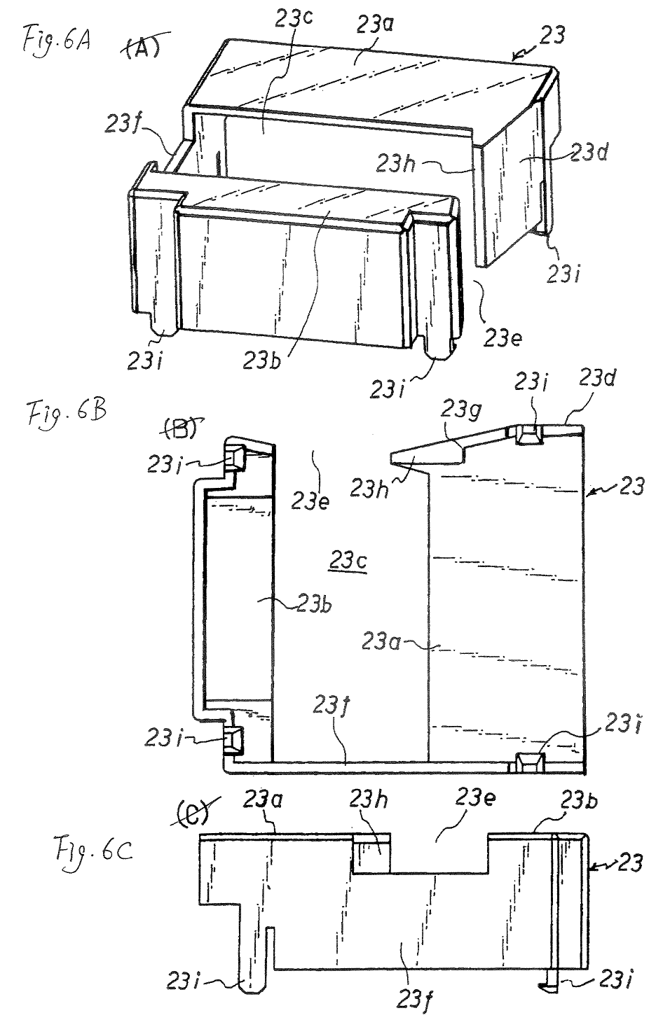

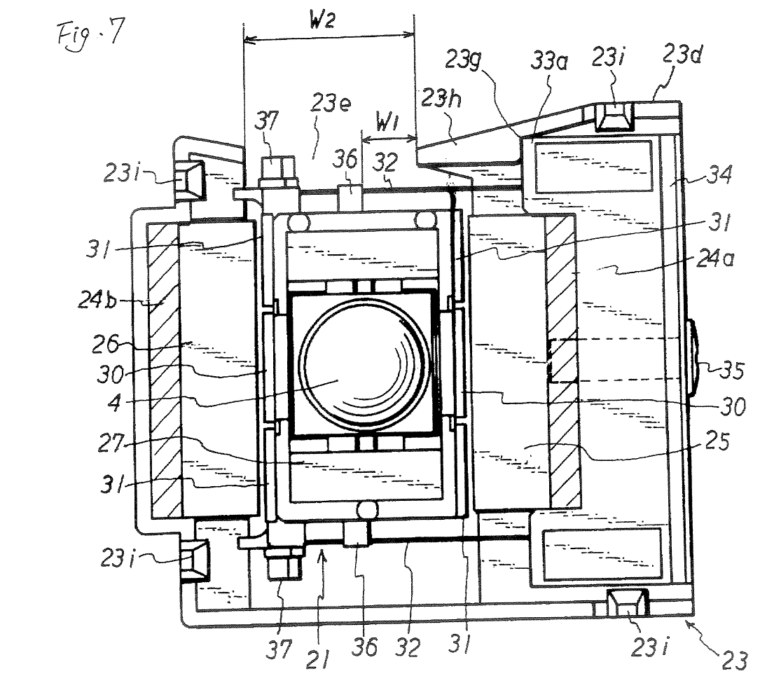

FIG. 4 is a perspective view illustrating the external appearance of the objective lens driving device 21. FIG. 5 is a perspective view illustrating a state in which its cover 23 is removed. FIGS. 6A to 6C are diagrams illustrating the cover 23. FIG. 7 is a bottom view of the objective lens driving device in accordance with the embodiment with a bottom of its yoke base 24 omitted. In FIGS. 4, 5, and 7, reference numeral 24 denotes a yoke base which is fixed to the optical pickup 3. This yoke base 24 has a rectangular frame shape formed by stamping and bending an iron plate, and has rising portions 24a and 24b which form a pair at both ends thereof Reference numerals 25 and 26 denote permanent magnets which are fixed to opposing surfaces of these rising portions 24a and 24b.

Reference numeral 27 denotes a lens holder which is installed between the permanent magnets 25 and 26, and the above-described objective lens 4 is fixed to this lens holder 27 A tracking coil 30 and a focus coil 31 are respectively fixed to surfaces of the lens holder 27 opposing the permanent magnets 25 and 26.

It should be noted that in the objective lens driving device in accordance with this embodiment a tilt coil is provided in such a manner as to surround the lens holder 27, but its illustration is omitted.

Reference numeral 32 denotes a wire that works as a support member for supporting the lens holder 27, and these wires 32 are provided in plural numbers on both the left and right sides of the lens holder 27. Reference numeral 33 denotes a wire base that works as a support base for holding one end side of each wire 32. Reference numeral 34 denotes a circuit board which is connected to the tracking coil 30 and the focus coil 31 through the wires 32. Cross-sectional shape of the support member may be circular, elliptical, square, rectangular, or the like.

As shown in the bottom view of FIG. 7, the wire base 33 is bonded to the rising portion 24a of the yoke base 24 in abutment against or close proximity to it. Further, this wire base 33 together with the circuit board 34 is fixed to the rising portion 24a of the yoke base 24 by means of a screw 35.

A distal end side of the wire 32 is fixed to each of a pair of fixing portions 36 provided projectingly on both side surfaces of the lens holder 27. Further, the wire 32 is fixed to a tying portion 37 for tying end surfaces of the tracking coil 30 and the focus coil 31 by such as soldering or welding, and is electrically connected to these coils 30 and 31.

As shown in FIGS. 6A to 6C, the cover 23 of the objective lens driving device 21 has an open lower-side structure, and a top plate portion is divided into two top plate portions 23a and 23b. One top plate portion 23a covers one rising portion 24a of the yoke base 24, the permanent magnet 25, the wire base 33, and the circuit board 34. Meanwhile, the other top plate portion 23b covers the other rising portion 24b and the permanent magnet 26. An opening 23c between the both top plate portions 23a and 23b is provided to allow the objective lens 4 to oppose the optical disk side. In addition, a portion of a side plate portion 23d corresponding to the inner side, in the radial direction of the disk, of the cover 23, i.e., a portion of that portion which is in close proximity to an outer peripheral surface of the spindle motor 2, is cut off (at 23e). As shown in FIG. 3, this cut-off portion 23e is formed such that a line Y connecting the center of the spindle motor 2 and the objective lens 4 is included in the range of this cut-off portion 23e. In this embodiment, this cut-off portion 23e is a portion which opposes the fixing portion 36 for fixing the wires 32 to the lens holder 27 and its vicinity in the portion opposing the wires 32, and its portion opposing the tying portion 37 is also cut off. The other side plate portion 23f is not cut off.

A reentrant portion 23g for abutment against a corner portion of the wire base 33 is provided in the vicinity of the cut-off portion 23e on an inner surface of the side plate portion 23d on the side where the cut-off portion 23e is formed.

In addition, a portion 23h adjacent to the cut-off portion 23e in the side plate portion 23d is formed into the shape of a tapered projection, such that the closer to the cut-off portion 23e the portion is, which is a distal end portion, the thinner the wall thickness is, and the closer to the lens holder side the outer surface of the side plate portion 23d is. A proximal end portion of this tapered portion 23h is formed integrally with the aforementioned top plate portion 23a. As for this tapered portion 23h, its inner surface is parallel to the side surface of the lens holder 27, and its outer surface is formed so as to be recessed toward the inner side of the cover 23. Further, a portion 24c of the yoke base 24 which corresponds to the cut-off portion 23e and the tapered portion 23h is formed in an arcuate shape which substantially conforms to the outer peripheral shape of the spindle motor 2.

Retaining pawls 23i are respectively provided at lower edge portions of the four corners of the cover 23. The cover 23 is fixed to the yoke base 24 as the lower edges of the cover 23 are placed on the upper surfaces of peripheral portions of the yoke base 24, and the retaining pawls 23i are retained at the lower edges of the yoke base 24. At this time, as shown in FIG. 7, the reentrant portion 23g provided on an inner surface portion of the side plate portion 23d abuts against a corner portion 33a of the wire base 33. It should be noted that the reentrant portion 23g does not necessarily need to abut against the corner portion 33a, and it suffices if the reentrant portion 23g is in close proximity to the corner portion 33a to such an extent that when the cover 23 is grasped, the reentrant portion 23g abuts against the corner portion 33a to prevent the bending of the side plate portion 23d including the tapered portion 23h.

As shown in FIGS. 4 and 7, in the state in which this cover 23 is fitted to the yoke base 24, the wire base 33 is covered by its top plate portion 23a and side plate portions 23d and 23f, and in the state in which the side plates of the cover 23 are grasped, the operator's fingers abut against the side plate portion 23f and the tapered portion 23h. Thus, the operator's fingers do not come into contact with a damping agent in the wire base 33. Furthermore, it is possible to prevent the entry of oil and water and prevent the deterioration of the damping agent.

In addition, the portion of each wire 32 between the wire base 33 and the fixing portion 36 is covered by more than its half by the side plate portion 23d. As the width W1 of the uncovered portion is set to about 3 mm or less, it is possible to prevent the operator's finger from coming into contact with these wires 32, thereby making it possible to prevent the deformation and breakage of the wires 32. It should be noted that the width W2 of the cut-off portion 23e which corresponds to a portion of each wire 32 and the tying portion 37 is set to 5.7 mm in this embodiment, and the interval between the fixing portion 36 and the tapered portion 23h, i.e., the width W1 of the uncovered portion of the wire 32, is set to 1.85 mm in this embodiment.

As shown in FIG. 3, in a case where the optical pickup 3 approaches the spindle motor 2 side, the fixing portion 36 of the lens holder 27 at a position in which the outer peripheral portion of the spindle motor 2 is closest to the fixing portion 36. In the invention, since the portion of this side plate portion 23d corresponding to this fixing portion 36 and its vicinity is cut off, the restriction of the moving range of the objective lens driving device 21 to the inner peripheral side of the optical disk is alleviated, so that the radius of the spindle motor 2 can be enlarged.

In this embodiment, the tying portion 37 is provided on the side surface portion of the lens holder 27, which projects, and the amount of projection of this tying portion 37 is greater than that of the fixing portion 36 for fixing the wires 32, as shown in FIG. 7. For this reason, since the cut-off portion 23e is formed including the portion corresponding to this tying portion 37, the amount of projection of the objective lens driving device 21 toward the spindle motor 2 side becomes small. Hence, even in the lens holder 27 having the tying portion 37, the restriction of the moving range of the objective lens driving device 21 to the inner peripheral side of the optical disk is alleviated, so that the radius of the spindle motor 2 can be enlarged.

In addition, in this embodiment, since the reentrant portion 23g is provided in the vicinity of the cut-off portion 23e on the inner surface of the side plate portion 23d, and this reentrant portion 23g is abutted against the corner portion 33a of the wire base 33, so that the combination strength improves, and the bending of the tapered portion 23h of the side plate portion can be prevented.

In addition, in this embodiment, the portion of the side plate portion 23d close to the cut-off portion 23e is formed into the tapered shape such that the closer to the cut-off portion 23e, the more the outer surface of the side plate portion is recessed toward the inner side of the cover 23. Therefore, a structure is easily realized which makes it possible to prevent the interference between the spindle motor 2 and the side plate portion 23d of the cover 23, and which permits the movement of the objective lens driving device 21 to the inner peripheral side of the optical disk.

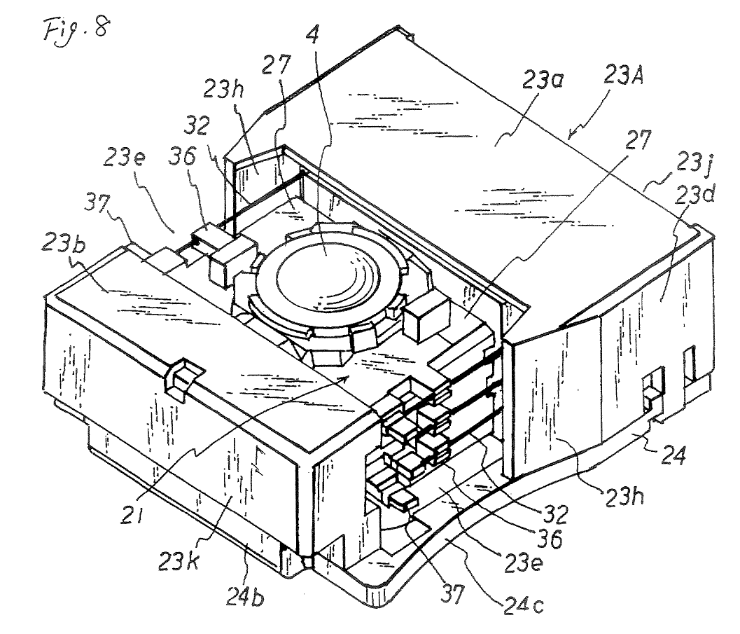

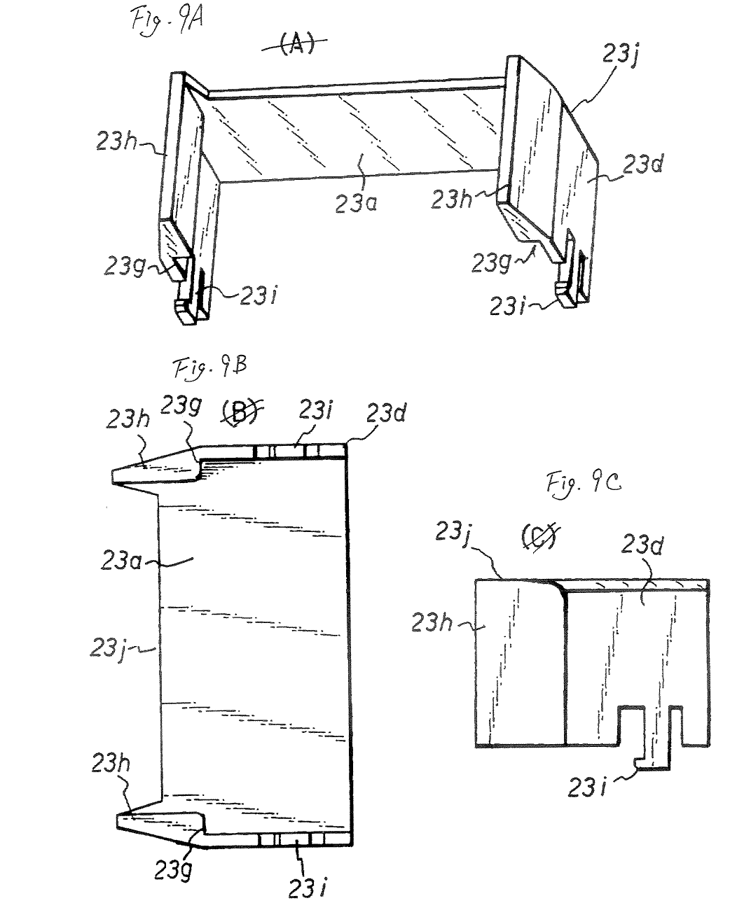

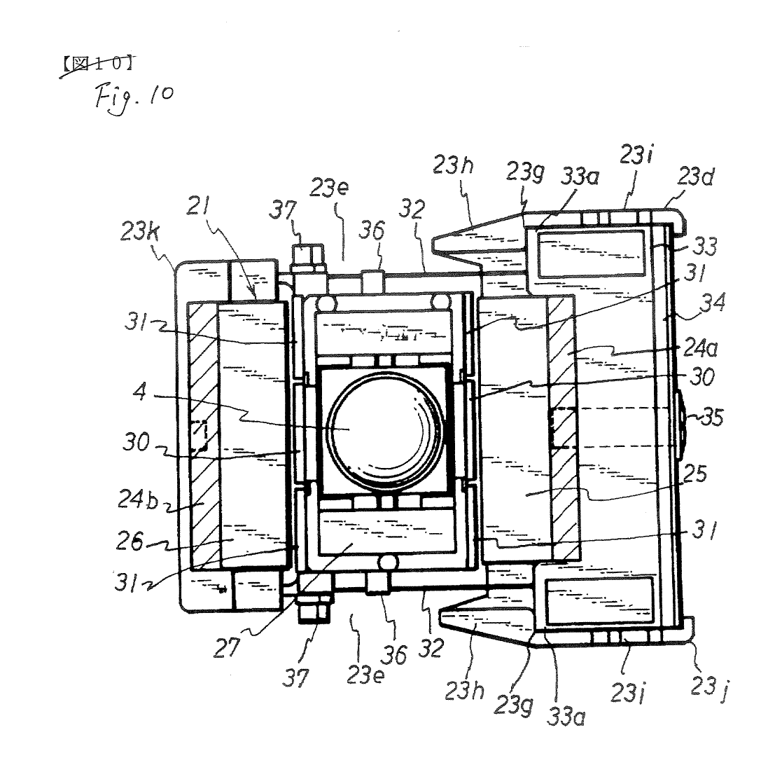

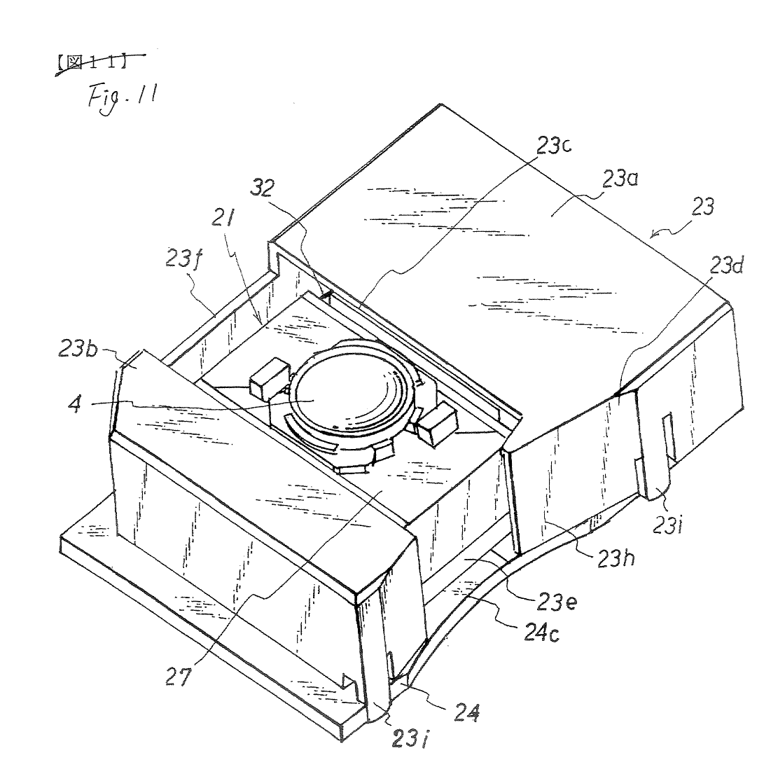

FIGS. 8 to 10 are diagrams illustrating another embodiment of the invention. In a cover 23A in this embodiment, the aforementioned cut-off portion 23e is provided on each of the radially inner and outer sides of the disk so as to divide the cover 23A into a divided body 23j for covering the wire base 33, the rising portion 24a, and the permanent magnet 25, as well as a divided body 23k for covering the rising portion 24b and the permanent magnet 26.

In this embodiment, the same portions as those of the foregoing embodiment are denoted by the same reference numerals, and advantages similar to those of the foregoing embodiment can be obtained in this embodiment as well. In addition, in this embodiment, since the two divided bodies 23j and 23k are each provided with side plate portions on both sides and are respectively formed substantially symmetrically, it is possible to reduce the occurrence of strain during the molding and shrinkage of a plastic, thereby making it possible to make the fabrication error small.

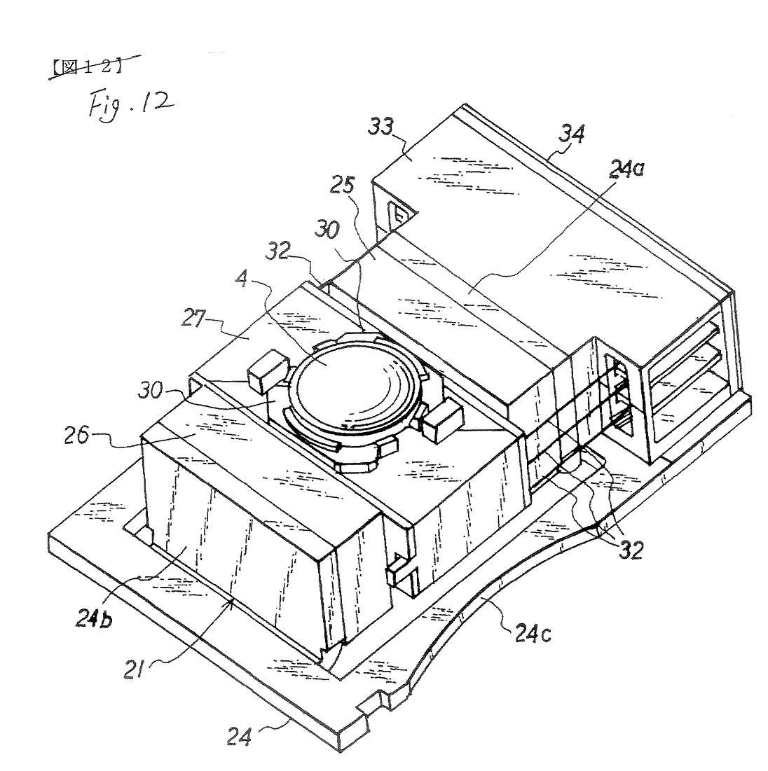

FIG. 11 is a perspective view illustrating still another embodiment of the objective lens driving device in accordance with the invention, and FIG. 12 is a perspective view in which its cover is removed. In FIGS. 11 and 12, the same reference numerals as those of FIGS. 4 and 5 denote portions or parts exhibiting the same functions. In the embodiment shown in FIGS. 11 and 12, a structure is adopted in which the distal end of each wire 32 for supporting the lens holder 27 is not exposed to the side surface of the lens holder 27. The structure in which each wire 32 is thus not exposed to the side surface of the lens holder 27 can be realized such as by a structure in which the wires 32 are inserted in holes provided in the lens holder 27 and are partially fixed in parts of the holes or by an integrally molding means. Further, the structure in which each wire 32 is not exposed to the side surface of the lens holder 27 can also be realized such as by a structure in which a member for covering the side surface of the lens holder is attached to the fixing portion for fixing the wires 32 to the lens holder 27, or this the fixing portion is covered by a resin. In addition, it is also possible to adopt a structure in which the wires 32 are fixed to the upper surface portion (the surface on the recording medium 1 side) of the lens holder 27 and to the bottom portion (the surface on the opposite side of the recording medium 1) thereof

This application is based upon and claims the benefit of priorities of Japanese Patent Application No. 2005-228350 filed on Aug. 5, 2005 and No. 2006-146362 filed on May 26, 2006, the contents of which are incorporated herein by reference in its entirety.

1. An objective lens driving device which is mounted in an optical pickup in an optical reproducing or optical recording-and-reproducing apparatus which has a spindle motor for rotating a disk and in which the optical pickup is installed movably along a pair of guide arms provided in a radial direction of a disk, the objective lens driving device comprising:
a structure in which a lens holder is fixed to one end side of a support member whose other end side is held on a support base;
a cover which covers at least a portion of the support member in a vicinity of the support base,
wherein of a pair of side plate portions respectively corresponding to inner and outer sides, in the radial direction of the disk, of the cover; a portion of that portion which is in close proximity to an outer peripheral surface of the spindle motor in at least the inner side plate portion is cut off.

2. The objective lens driving device according to claim 1, wherein the cover has a structure in which the cover is divided into a first half body for covering the support base and a second half body for covering an opposite side portion with the objective lens placed therebetween, the cut-off portion being formed between these divided bodies.

3. The objective lens driving device according to claim 1, wherein means is provided for preventing the deformation toward the inner side of a portion of the side plate portion located close to the cut-off portion.

4. The objective lens driving device according to claim 2, wherein means is provided for preventing the deformation toward the inner side of a portion of the side plate portion located close to the cut-off portion.

5. The objective lens driving device according to claim 3, wherein a reentrant portion is provided in the vicinity of the cut-off portion on an inner surface of the side plate portion, and the reentrant portion is adapted to abut against a corner portion of the support base so as to prevent the deformation toward the inner side of the portion of the side plate portion located close to the cut-off portion.

6. The objective lens driving device according to claim 4, wherein a reentrant portion is provided in the vicinity of the cut-off portion on an inner surface of the side plate portion, and the reentrant portion is adapted to abut against a corner portion of the support base so as to prevent the deformation toward the inner side of the portion of the side plate portion located close to the cut-off portion.

7. The objective lens driving device according to claim 1, wherein the portion of the side plate portion located close to the cut-off portion is formed into a tapered shape, such that the closer to the cut-off portion, the more an outer surface of the side plate portion approaches a lens holder side.

8. The objective lens driving device according to claim 2, wherein the portion of the side plate portion located close to the cut-off portion is formed into a tapered shape, such that the closer to the cut-off portion, the more an outer surface of the side plate portion approaches a lens holder side.

9. An optical pickup having the objective lens driving device according to claim 1.

10. An optical recording-and-reproducing apparatus having the optical pickup according to claim 9.
